(19) United States
(12) Patent Application Publication
(10) Pub. No.: US 2024/0073056 A1
(43) Pub. Date: Feb. 29, 2024

(54) FLOW PROGRAMMING PLATFORM FOR HOME AUTOMATION

(71) Applicant: Simple Things Inc., Palo Alto, CA (US)

(72) Inventors: Volodymyr Ishchenko, Kharkiv (UA); Sergey Varlamov, Opatija (CU); Kristopher Linquist, Santa Clara, CA (US)

(21) Appl. No.: 18/364,755

(22) Filed: Aug. 3, 2023

Related U.S. Application Data
(60) Provisional application No. 63/374,155, filed on Aug. 31, 2022.

(51) Int. Cl. H04L 12/28; G06F 9/455; G06F 9/54

(52) U.S. Cl. CPC H04L 12/2834; G06F 9/45504; G06F 9/547; H04L 12/282

(57) ABSTRACT

A visual flow-based programming platform enables entities to build automations for smart home systems. Flows link contact closures to adapters of devices in an entity's smart home system. Nodes provide logic and other functions that are interconnected to build the flows in a flow editor that executes in the cloud. The flows are exported, for example, as JSON files and run by a separate flow interpreter that executes at an entity's local hub. Automations can be shared between entities by sharing flows, without exposing private information about each entity's devices.

### CROSS-REFERENCE TO RELATED APPLICATION(S)

This application claims the benefit of U.S. Provisional Application No. 63/374,155, filed Aug. 31, 2022 (attorney docket no. 142343.8005.US00), incorporated herein by reference.

### TECHNICAL FIELD

The present disclosure is generally related to home automation.

### BACKGROUND

Flow-based programming is a programming paradigm that defines software applications as networks of “black box” processes, which exchange data across predefined connections by message passing, where the connections are specified externally to the processes. These black box processes can be reconnected in different ways to form different applications without having to be changed internally. Flow-based programming is thus naturally component-oriented.

Flow-based programming defines each application not as a single, sequential process, but as a network of asynchronous processes communicating by means of streams of structured data chunks, called “information packets.” In this view, the focus is on the application data and the transformations applied to it to produce the desired outputs. The network is defined externally to the processes, as a list of connections which is interpreted by a piece of software, usually called the “scheduler”.

The processes communicate by means of fixed-capacity connections. A connection is attached to a process by means of a port, which has a name agreed upon between the process code and the network definition. More than one process can execute the same piece of code. At any point in time, a given information packet can only be “owned” by a single process or be in transit between two processes. Ports may either be simple, or array-type. It is the combination of ports with asynchronous processes that allows many long-running primitive functions of data processing, such as Sort, Merge, Summarize, etc., to be supported in the form of software black boxes.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure. The drawings should not be taken to limit the disclosure to the specific embodiments depicted, but rather are for explanation and understanding only.

FIG. 1 is a block diagram illustrating an example system architecture in accordance with embodiments of the disclosed technology.

FIG. 2A is a drawing illustrating an example flow-based program editor in accordance with embodiments of the disclosed technology.

FIG. 2B is a drawing illustrating an example contact closure node in accordance with embodiments of the disclosed technology.

FIG. 3 is a drawing illustrating an example flow-based program editor in accordance with embodiments of the disclosed technology.

FIG. 4 is a drawing illustrating an example flow-based program including a sync node in accordance with embodiments of the disclosed technology.

FIG. 5 is a drawing illustrating an example mapping interface between nodes in accordance with embodiments of the disclosed technology.

FIG. 6 is a flow diagram illustrating an example process for operating a flow-based platform in accordance with embodiments of the disclosed technology.

FIG. 7 is a block diagram illustrating an example machine learning system accordance with embodiments of the disclosed technology.

FIG. 8 is a block diagram illustrating an example computer system used to implement features of some embodiments of the disclosed technology.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Home automation systems, also known as smart home systems, are being implemented in increasing numbers, as part of a growing Internet of Things (IoT). The number and types of Internet-connected devices that form home automation systems also continue to increase, including lightbulbs, speakers, electrical outlets, thermostats, televisions, door locks, laundry machines, refrigerators, motion sensors, proximity sensors, and many more. These devices are often controlled using various disparate platforms, hardware, and applications.

Entities can customize or program a home automation system, such that different devices within a smart home are programmed to interact with one another. For example, a smart coffee machine can be programmed to turn on synchronously with an alarm of a smartphone in the morning. In another example, a smart lighting system can be programmed to flash or change colors in response to music from smart speaker.

However, current programmable home automations often reside at one of two extremes. On one end, many home automation devices can only be programmed relatively easily, such as through a wizard on a mobile app, but are limited to performing simple tasks. On the other end, some home automation systems can be configured to perform complex tasks with multiple interacting components, multiple conditions, cascading actions, etc. But setting up these complex home automation systems often requires a high level of technical knowledge that many users do not possess. Thus, a platform for creating home automation tasks is needed that is both easy-to-use and powerful enough to enable a wide range of automated tasks.

Embodiments of the present technology address these issues by providing a unique flow-based programming platform for home automation. In some embodiments, one or more computer processors of a hub determine that an adapter of a device has been installed on the hub. The adapter operates the device (e.g., a smart sensor), provides a programming interface to control and manage specific lower-level interfaces linked to the device, and communicates with the device through a communications subsystem. The adapter is managed by a resource manager microservice associated with the hub. In response to determining that the adapter has been installed, the device is provisioned via an application on a computer device. Provisioning the device prevents sharing an address of the device with other devices. A node is generated for a flow associated with the hub. Operation of the device is programmed by linking the node to other nodes in the flow. The node and the adapter communicate using Web Application Messaging Protocol (WAMP). The node is isolated from the adapter using remote procedure calls (RPCs). The device is operated by executing the flow on a virtual machine.

In some implementations, a computer system determines that an adapter of a device has been installed on the hub. In response to determining that the adapter has been installed, the device is provisioned via an application on a computer device. A feature vector is extracted from a voice command or a text command, wherein the voice command or a text command is directed to the operation of the device. Using a machine learning model, a flow is generated for operating the device based on the feature vector. The flow comprises a node associated with the device. The device is operated by executing the flow on a virtual machine.

The benefits and advantages of the systems, methods, and apparatuses described herein include the use of a flow-based programming platform to build automations more easily and quickly than conventional platforms while maintaining a high degree of customizability. In addition, the flows are built using a flow editor interface the enables entities to visualize their programs in an intuitive manner. Flow-based programs, sometimes referred to as “flows”, are further implemented to provide firewall capabilities and data management capabilities. For instance, as a sandbox on top of a sandbox, a flow-based program of an entity can be securely shared with another entity (recipient) who imports the flow-based program. No personal information is shared, improving personal data security. In addition, device security is not compromised because sensitive device information is not shared when sharing flows. In addition, the flow-based programming platform provides a secure method for applications of different devices to talk to each other without having full access to each other. Finally, flows are built or authored separately from flow runtime, providing an additional layer of security.

In addition, as described above, flow-based programming involves mapping the flow of data between various asynchronous processes. However, home automations often require certain events to occur in a sequence or follow specific patterns. The FBP platform of the present disclosure introduces various nodes adapted for home automation tasks that can be used to manage data within a flow. Similarly, by using machine learning techniques, such as convolutional neural networks (CNNs), which use shared weights in convolutional layers, the disclosed implementations enable reduction of memory footprint and improvement in performance.

### Architecture

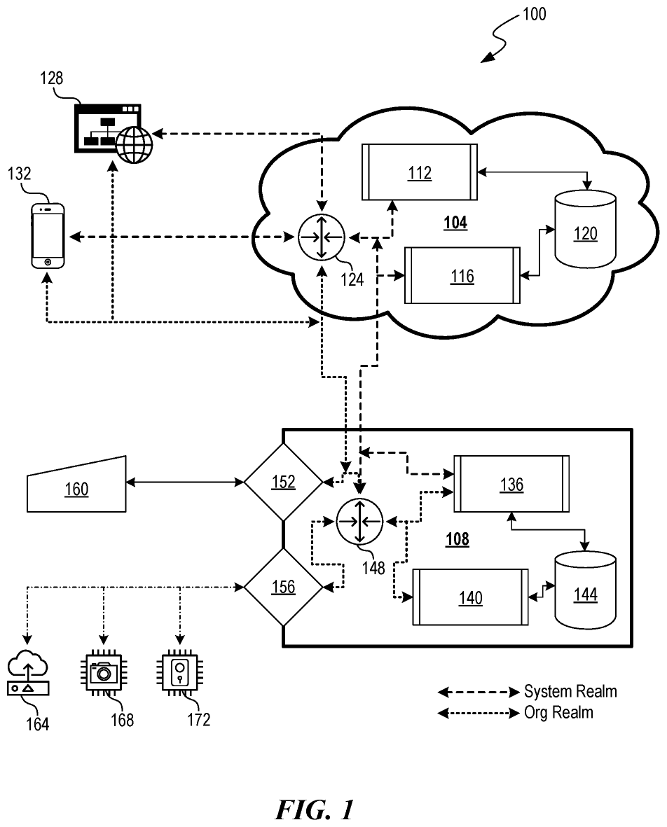

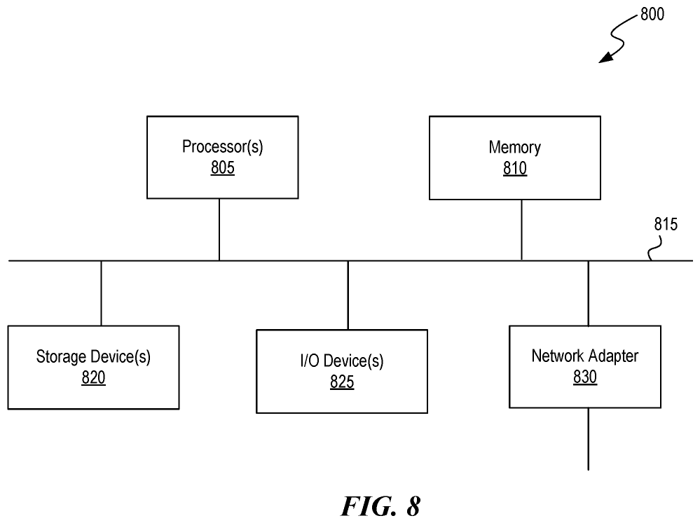

FIG. 1 is a block diagram illustrating an example system architecture 100 in accordance with embodiments of the disclosed technology. The system architecture 100 can be implemented in a smart building, such as a home, office, vehicle, or vessel that uses network-connected devices to enable remote monitoring and management of appliances and systems, such as lighting and heating. The architecture 100 includes a hub 108, smart devices 164, 168, 172, and a cloud computing system 104. The smart device 164 is a smart sensor, the smart device 168 is a smart camera, and the device 172 is a smart lock (e.g., for a door, window, safe, or cabinet). In some embodiments, architecture 100 includes other smart devices such as a water sprinkler, a door alarm, a security camera, a music player, or a smart speaker. The architecture 100 is implemented using the components of the example computer system 800 illustrated and described in more detail with reference to FIG. 8. Likewise, embodiments of the architecture 100 can include different and/or additional components or can be connected in different ways.

FIG. 1 shows a system realm (larger dash lines) and an organization realm (smaller dash lines). In the organizational realm the hub and cloud server communicate with each other via their respective Web Application Messaging Protocol (WAMP) routers. Within the organizational realm the mobile app and web app can communication directly with the hub via the hub's WAMP router and the zone input can communicate directly with the cloud server via the cloud server's WAMP router. In some implementations, the zone input can communicate using LoRa to a microservice on the local hub 108, which publishes events to the local WAMP router. The organizational realm in the embodiment shown in FIG. 1 implements an alarm service at the hub. The system realm provides system services, such as those provided by the account service and device registry at the cloud server and the core services at the hub.

The cloud 104 comprises one or more remote, globally distributed, fault tolerant, and scalable servers that host global services. The cloud communicates with mobile apps, web apps, and hubs via WAMP over a web socket. In FIG. 1, the cloud 104 includes a WAMP router 124 and is in communication with an account service 112 and a device registry 116, each of which has access to a PostgreSQL open-source object-relational database 120. The cloud server communicates with mobile apps 132 and web apps 128.

The cloud computing system 104 provides the delivery of computing services—including servers, storage, databases, networking, software, analytics, and intelligence—over the Internet to offer faster innovation, flexible resources, and economies of scale. The cloud computing system 104 includes a Web Application Messaging Protocol (WAMP) router 124 and is in communication with an account service 112 and a device registry 116, each of which has access to an open-source object-relational database 120 (e.g., a PostgreSQL open-source object-relational database). The cloud computing system 104 communicates with mobile apps 132 and web applications (web apps 128) operating on user devices. Each user device is one of a smartphone, a tablet, a laptop, a smartwatch, etc. The router 124 is a WAMP router that facilitates communication between the web apps 128, mobile apps 132 on a user device, the account service 112, the device registry 116, the cloud computing system 104, and the hub 108.

The hub 108 comprises a small computer that is installed in the home or building and hosts first and third-party application services. The hub communicates with system devices and sensors such as contact sensors, motion (radar) sensors, cameras, etc., via wired or wireless interfaces (e.g., LoRA or USB).

The hub 108 includes a WAMP router 148 in communication with core services, also referred to as microservices 136, and an alarm service 140, each of which has access to a local SQLite database 144. In FIG. 1, a hub 108 includes a WAMP router 148 in communication with core services 136 and an alarm service 140, each of which has access to a local SQLite database 144. The hub communicates with zone inputs 160 via a USB port 152 and communicates with sensors 164, a camera 168, and door locks 172 via a Low Power, Wide Area (e.g., LoRa) networking protocol connection 156. The hub 108 communicates with zone inputs 160 via a USB port 152 and communicates with sensor(s) 164, camera 168, and door lock(s) 172 via a wireless protocol connection 156, e.g., a Long Range (LoRa) networking protocol connection or a Zigbee networking protocol connection. In some embodiments, at least one of the hub 108 or smart devices 164, 168, 172 receives electrical power and network connectivity via a universal serial bus (USB) type C port.

A smart device (e.g., sensor(s) 164, camera 168, or door lock 172) can be connected to hub 108 using LoRa communication. LoRa is a physical proprietary radio communication technique based on spread spectrum modulation techniques derived from chirp spread spectrum (CSS) technology. LoRa-WAN defines a communication protocol and system architecture. Together, LoRa and LoRa-WAN define a Low Power, Wide Area (LPWA) networking protocol designed to wirelessly connect battery operated devices to the Internet in regional, national or global networks, and targets key Internet of things (IoT) requirements such as bi-directional communication, end-to-end security, mobility and localization services. The low power, low bit rate, and IoT use distinguish this type of network from a wireless WAN that is designed to connect entities or businesses, and carry more data, using more power. An entity, as described herein, can be an individual user, an organization, a company such as a home security provider, etc. The LoRa-WAN data rate ranges from 0.3 kbit/s to 50 kbit/s per channel.

Any other smart home gadgets and devices are operated similarly using the embodiments disclosed herein, e.g., smart speakers, entertainment systems, surveillance systems, sprinkler systems for a garden, smart refrigerators and other smart home appliances, smart mirrors, smart locks, smart lighting, smart entry systems, climate control systems, smart detectors, smart sensors, or smart Internet routers. The WAMP router 148 facilitates communication between the microservices 136, the alarm service 140, the USB port 152, the wireless protocol connection 156, the cloud computing system 104, and the hub 108. In an embodiment, when there is no Internet service, the microservices 136 can still run or execute inside the premises because of WAMP router 148 on hub 108.

The WAMP pub/sub OTA messaging updates the UI of the mobile app 132 over a wireless network. The WAMP pub/sub OTA messaging can be used for different embedded systems including mobile phones, tablets, or set-top boxes. In some embodiments, firmware updates can be delivered OTA. In some embodiments, a device's operating system, applications, configuration settings, or parameters such as encryption keys can be updated. OTA updates are usually performed over Wi-Fi or a cellular network, but can also be performed over other wireless protocols, or over the local area network.

In some embodiments, the WebSocket protocol is used to deliver bi-directional (soft) real-time and wire traffic connections to mobile app 132. WAMP provides application developers with a level of semantics to address messaging and communication between components in distributed applications. WAMP provides PubSub functionality as well as routed Remote Procedure Calls (rRPCs) for procedures implemented in WAMP router 148. Publish/Subscribe (PubSub) is a messaging pattern where a component, the Subscriber, informs WAMP router 148 that it wishes to subscribe to a topic. Another component, a Publisher, publishes to this topic, and the router distributes events to all Subscribers.

In some embodiments, text or graphical input is received from a user input device. The user input device can be user device, another user input device such as mounted on a wall of a building or embedded in furniture, or part of another device such as a music system. The text or graphical input references a smart device (e.g., smart lock 172). A new RPC based on the text or graphical input is sent from a microservice to the cloud WAMP router 124 over the WebSocket connection. The cloud WAMP router 124 is caused to route the new RPC into hub 108. For example, the microservice is caused to establish a WebSocket connection to the cloud WAMP router 124. The microservice can execute on hub 108. In some embodiments, the microservice is precluded from executing on a software Snap™ package. An adapter executes on the cloud (e.g., cloud computing system 104) or on a computer device (e.g., user device) of an entity. A portion of an automated flow corresponding to the smart device (e.g., smart lock 172) can be modified. The automated flow is generated using flow-based programming as described herein.

In some embodiments, hub 108 determines that smart lock 172 is a third-party device or legacy door lock. Responsive to determining that a third-party device is installed, a user interface (UI) of mobile application 132 of a user device of an entity is reconfigured using WAMP pub/sub messaging delivered over-the-air (OTA) to incorporate a UI widget corresponding to smart lock 172. A user input device can also receive text or graphical input via a UI widget on the user input device. The UI widget (also known as a graphical control element or a control) in a graphical user interface (GUI) is an element of interaction, such as a button or a scroll bar. Controls are software components that an entity interacts with through direct manipulation to read or edit information about an application.

In some embodiments, the text or graphical input references a smart device (e.g., smart lock 172). The user input device is caused to send a new RPC based on the text or graphical input from the user input device to hub 108 over the hub WAMP router 148 for hub 108 to execute the RPC, while precluding the RPC executing on the user input device. For example, cloud data stored in the cloud (e.g., using the cloud computing system 104) is accessed using hub 108 while the cloud is precluded from accessing hub data stored in hub 108.

In some embodiments, an operating system (OS) of hub 108 is updated using an incremental code update delivered OTA in a software Snap™ package. The OS manages software and hardware of the hub 108 and performs basic tasks such as file, memory and process management, handling input and output, and controlling peripheral devices (e.g., smart devices 164, 168, 172). Snap™ is a software packaging and deployment system for operating systems that use the Linux kernel and the systemd init system. The packages, called snaps, and the tool for using them, snapd, work across a range of Linux™ distributions and allow upstream software developers to distribute their applications directly to entities. Snaps are self-contained applications running in a sandbox with mediated access to the host system. Snap™ is operable for cloud applications, Internet of Things devices, and desktop applications.

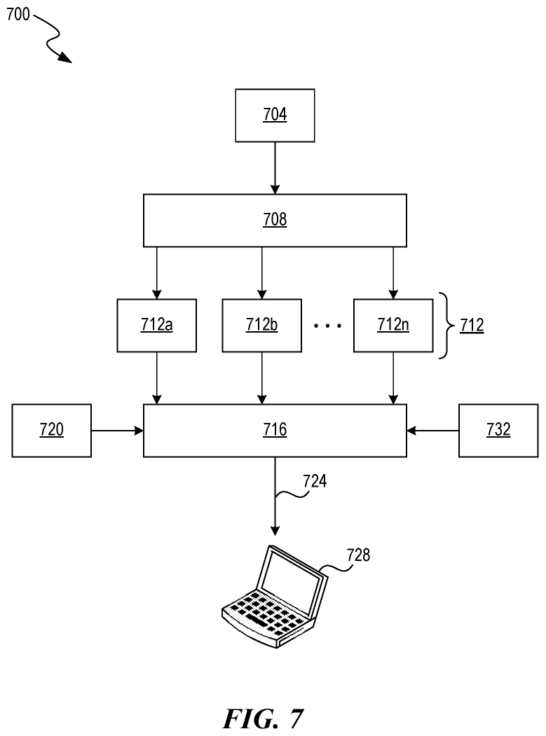

In some embodiments, a smart device (e.g., smart device 168) includes a 60 gigahertz (GHz) radar sensor. The radar sensor includes an antenna that emits a high-frequency (60 GHz) transmitted signal, which can include a modulated signal with a lower frequency (10 MHz). The sensor can be used to detect motion of people, animals, or objects within rooms of a smart building over a number of days using the 60 GHz radar sensor. Patterns of the motion of people or objects are generated based on detecting the motion. In some embodiments, feature vectors are extracted from the patterns of the motion. An example feature vector 712 and example input data 704 is illustrated and described in more detail with reference to FIG. 7. A machine learning (ML) model is trained, based on the feature vectors, to detect movement of the people or the objects within rooms of the smart building especially when the movement mismatches the predicted patterns of the motion. An example machine learning model 716 is illustrated and described in more detail with reference to FIG. 7. In some embodiments, features are extracted from data captured by the 60 GHz radar sensor. A notification is sent using the machine learning model to user device 204 based on the features. The notification indicates a mismatch detected in the features.

In some embodiments, feature vectors are extracted from training images depicting persons or objects associated with the smart building. Feature extraction is performed as described in more detail with reference to FIG. 7. A machine learning model is trained, based on the feature vectors, to detect new persons or new objects that the training images are free of. A smart device can be a security camera (e.g., smart camera 168). Features are extracted from a video captured by the security camera. A notification is generated using the machine learning model to a user device based on the features. The notification indicates that a new person or a new object has been detected in the video.

In some embodiments, operating a smart device (e.g., smart camera 168) and a third-party device (e.g., smart door lock 172) obviates the need for an Internet connection to the hub 108. Hub 108 can communicate with the smart device and the third-party device using short-range wireless communication. The short-range wireless communication can be near field communication (NFC), Zigbee, Bluetooth, Wi-Fi, radio frequency identification (RFID), Z-wave, infrared (IR) wireless, 3.84 MHz wireless, EMV chips, or minimum-shift keying (MSK). NFC is a set of communication protocols for communication between two electronic devices over a distance of 4 cm or less. NFC devices can act as electronic identity documents or keycards. NFC is based on inductive coupling between two antennas present on NFC-enabled devices—for example a smartphone and an NFC card-communicating in one or both directions, using a frequency of 13.56 MHz in the globally available unlicensed radio frequency ISM band using the ISO/IEC 18000-3 air interface standard at data rates ranging from 106 to 424 kbit/s. An NFC-enable devices, such as a smartphone (NFT creator device) can act like an NFC card, allowing entities to perform transactions such as payment or ticketing.

Zigbee is a wireless technology developed as an open global standard to address the unique needs of low-cost, low-power wireless IoT networks. The Zigbee standard operates on the IEEE 802.15.4 physical radio specification and operates in unlicensed bands including 2.4 GHz, 900 megahertz (MHz) and 868 MHz. Bluetooth technology is a high-speed low powered wireless technology link that is designed to connect phones or other portable equipment together. The Bluetooth specification (IEEE 802.15.1) is for the use of low-power radio communications to link phones, computers, and other network devices over short distances without wires. Wireless signals transmitted with Bluetooth cover short distances, typically up to 30 feet (10 meters). It is achieved by embedded low-cost transceivers into the devices. Wi-Fi is a family of wireless network protocols, based on the IEEE 802.11 family of standards, which are commonly used for local area networking of devices and Internet access, allowing nearby digital devices to exchange data by radio waves.

RFID uses electromagnetic fields to automatically identify and track tags attached to objects. An RFID system consists of a tiny radio transponder, a radio receiver and transmitter. When triggered by an electromagnetic interrogation pulse from a nearby RFID reader device, the tag transmits digital data back to the reader. Passive tags are powered by energy from the RFID reader's interrogating radio waves. Active tags are powered by a battery and thus can be read at a greater range from the RFID reader, up to hundreds of meters.

Z-Wave is a wireless communications protocol on a mesh network using low-energy radio waves to communicate from appliance to appliance, allowing for wireless control of devices. A Z-Wave system can be controlled via the Internet from a smart phone, tablet, or computer, and locally through a smart speaker, wireless key fob, or wall-mounted panel. IR wireless is the use of wireless technology in devices or systems that convey data through infrared (IR) radiation. Infrared is electromagnetic energy at a wavelength or wavelengths somewhat longer than those of red light. The shortest-wavelength IR borders visible red in the electromagnetic radiation spectrum; the longest-wavelength IR borders radio waves.

### Flow Platform

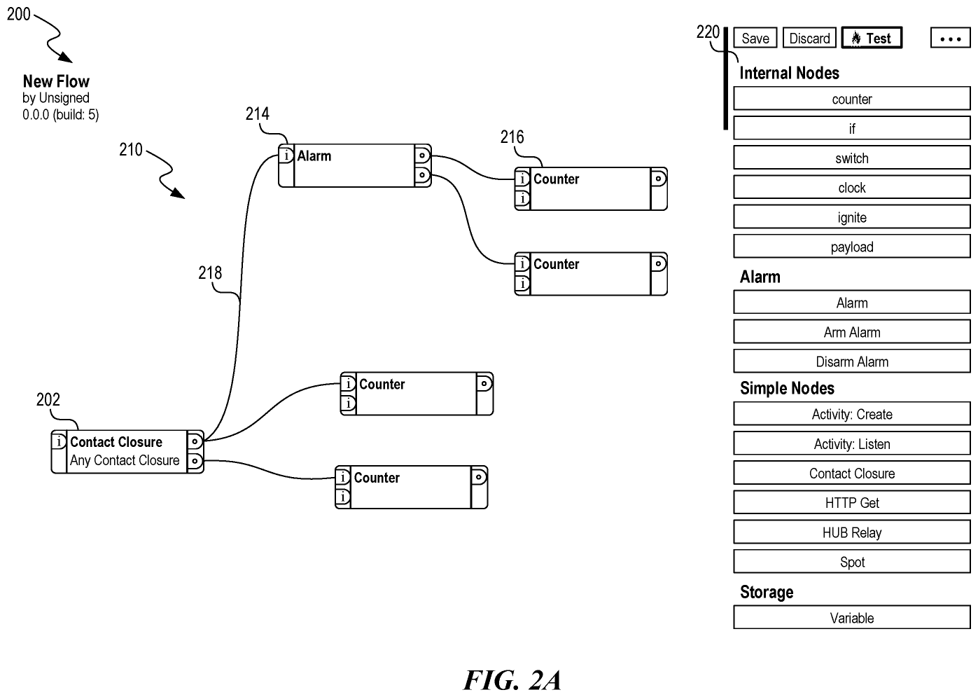

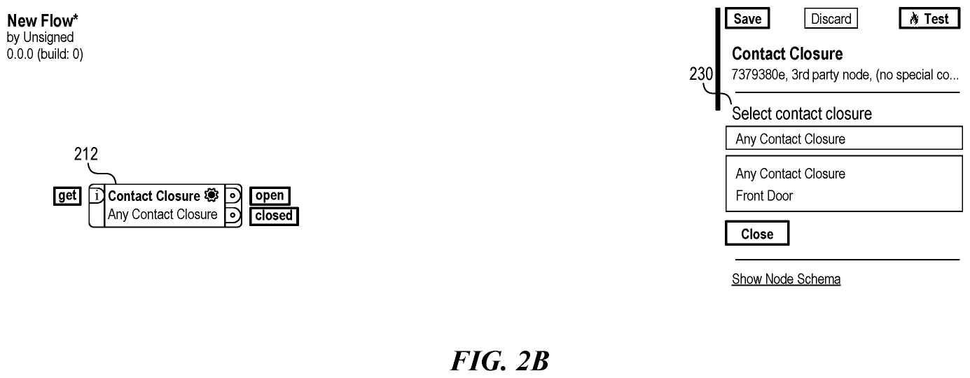

FIG. 2A is a drawing illustrating an example flow-based program editor 200 in accordance with embodiments of the disclosed technology. The flow-based program editor is also referred to as a “flow editor.” An application programming interface (API) for the flow editor 200 is provided by a flow Service that runs on the hub 108. A flow-based program, also referred to as a “flow,” can be built by linking nodes together. Nodes are visual programming blocks implemented to provide contact closures and logic, and to communicate with adapters and the flow runtime elements. The nodes, adapters, and flow runtime can communicate with each other through WAMP. For example, by using remote procedure calls (RPCs), the nodes, adapters, and flow runtime elements are isolated from each other. Likewise, embodiments of the flow-based program editor 200 can include different and/or additional components or can be connected in different ways.

The flow-based programming platform includes a number of nodes 220. These nodes can be arranged and interconnected as desired to manage the data flow. The nodes are movable within a user interface, such as by clicking and dragging on a desktop or laptop computer, or by providing a touchscreen input on a mobile device.

The nodes 220 can include high level nodes, such as contact closure node 202. In some embodiments, a node implements programmable logic. For example, nodes 220 can implement programming logic, such as switch statements, that enable more advanced automations. For example, the counter node 216 increments a number in response to inputs. Other internal nodes include “if,” “clock,” “ignite,” and “payload,” “cycle,” “toggle,” “repeater,” “math,” “logic,” “pub,” “sub,” and “random” nodes.

In addition, the nodes 220 can be associated with applications or devices. The “Alarm” nodes shown in FIG. 2A are associated with an alarm system, e.g., alarm service 140 as illustrated and described in more detail with reference to FIG. 1. For example, the alarm node 214 can be controlled by a mobile application on a user device. For instance, an entity can turn off the alarm or trigger the alarm manually. Besides alarms, nodes can be configured for a variety of specific applications or devices. For instance, nodes can be configured for heating or cooling systems, entertainment systems, or kitchen appliances.

Nodes or flows corresponding to third party services can be added to the flow-based programming platform. For instance, an entity may want to have a Facebook™ message sent to someone at 7 pm. Facebook™ could register those nodes on the platform and make the nodes available in the editor 200. The entity could then build a flow using Facebook™'s nodes in the editor 200. In addition, third parties could build flows for their products, which are then made available for entities. For example, a smart lightbulb manufacturer could build flows specifically for their smart lightbulb products. In some implementations, entities are able to customize these third-party flows.

New devices are added to the flow editor 200 though a provisioning process. Provisioning instructions are included in the new device's adapter (e.g., driver), which is installed on the hub 108 of FIG. 1. For example, an entity can install a Philips Hue® adapter onto their hub and provision Philips Hue devices, e.g., lightbulbs, through an application on their phone or computer. If an entity provisions six lightbulbs, for example, those lightbulbs become nodes available in the flow editor 200. The operation of the lightbulbs can then be programmed by linking the lightbulb nodes to other nodes.

An adapter refers to code that operates a device (e.g., the smart sensor 164 illustrated and described in more detail with reference to FIG. 1). A flow can be generated for controlling an adapter from a trigger, a condition, or an action. The adapter provides a programming interface to control and manage specific lower-level interfaces linked to the device. In some embodiments, the adapter communicates with the device through the communications subsystem (see FIG. 1) to which the device connects. When a calling program invokes a routine in the adapter, the adapter issues commands to the device. Once the device sends data back to the adapter, the adapter invokes routines in the original calling program. The adapter provides the interrupt handling required for asynchronous time-dependent device behavior. In some embodiments, a flow is exported as a JavaScript Object Notation (JSON) for operating a device in accordance with the flow.

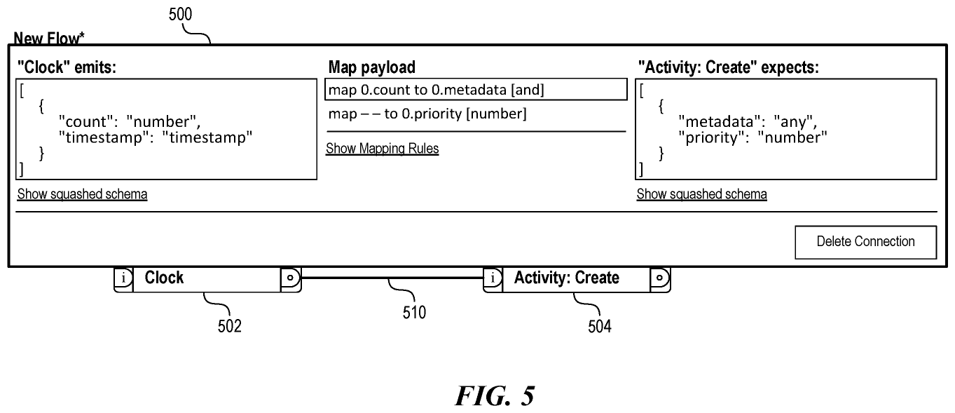

In some embodiments, the adapter coordinates between a first application programming interface (API) of the hub 108 and a second API of the smart device, while obviating communication between the hub 108 and the cloud computing system 104 (see FIG. 1). The embodiments thus enable the data to be held privately and not transferred to the cloud computing system 104. In some embodiments, the adapter interfaces with the hub 108 using WAMP. WAMP is described in more detail with reference to FIG. 5. The adapter gets or sets a device state (e.g., ON, OFF, RESET, SLEEP, or LISTENING) of the smart device. The adapter interfaces with the smart device using at least one of hypertext transfer protocol (HTTP), MQ Telemetry Transport (MQTT), or a local daemon, while obviating communication between the hub 108 and the cloud computing system 104.

The adapter can be a codebase that translates interfaces between APIs and individual device or device ecosystem APIs. Adapters have a “northbound” or “southbound” interface of WAMP and implement specific functions, such as “get device state” and “set device state.” The other interface of each adapter (i.e., “southbound” or “northbound,” respectively) will vary by adapter, e.g., MQTT, HTTP, or local daemon. A northbound interface of an adapter is an interface that allows the adapter to communicate with a higher level component, using the latter component's southbound interface. The northbound interface conceptualizes the lower level details (e.g., data or functions) used by, or in, the adapter, allowing the adapter to interface with higher level layers. The southbound interface decomposes concepts in the technical details, mostly specific to a single component of the architecture. A northbound interface is typically an output-only interface (as opposed to one that accepts user input).

The hub 108 includes adapters pre-installed for devices (e.g., contact closure, or keypad). Additional adapters can be installed from an “adapter store.” The adapter includes a manifest (JSON) which includes properties such as adapter_id, name, input fields required for provisioning, or permissions required. The adapter announces its manifest to the resource manager microservice upon startup and the resource manager microservice stores it in its database. An Adapter SDK is provided in several languages that will accelerate the development of adapters for internal use and the developer community. The adapter is able to run in the cloud, on another device, or by a third party. The adapter's permissions allow it to only register RPCs and publish messages within a particular namespace.

The triggers, conditions, and actions associated with the new device are provided to the flow platform by the adapter associated with the device. For example, the triggers for a lightbulb can include “when lightbulb is turned on,” and actions can include turn on/off, set brightness, or set color. Then in the flow editor 200, the device appears as a node with the triggers, conditions, and actions specified by the adapter. However, other details regarding the device are not shown unless specified by the adapter. Provisioning devices in this manner improves the security of devices in the home automation system by reducing potential exposure of device information, such as addresses, device type, etc. Each adapter that is installed on the hub 108 (illustrated and described in more detail with reference to FIG. 1) is managed by a resource manager microservice, which tracks the triggers, conditions, and actions associated with each adapter.

In some implementations, an automated flow is generated for controlling at least one adapter in a smart building from at least one of a trigger, a condition, or an action. The adapter operates a smart device, and the smart device corresponds to a node in the automated flow. For example, hub 108 determines that a third-party device is installed in the smart building. Responsive to determining that the third-party device is installed, a new adapter is generated for the third-party device. A new node corresponding to the third-party device is generated in the automated flow. The smart device and the third-party device are operated using at least one microservice to issue remote procedure calls (RPCs) from the hub 108 via the adapter and the new adapter to the smart device and the third-party device over the hub WAMP router in accordance with the automated flow by referencing the new node, while obviating communication between the hub and the cloud.

In some embodiments, a node corresponding to a device is added to a flow. The node-based flow is used to define object-oriented (OO) classes or objects in an engine of the hub 108. Nodes are the primary building block of the automated flow. When the automated flow is running, messages are generated, consumed and processed by nodes. For example, nodes include code that runs in a JavaScript (.js) file, and an HTML file consisting of a description of the node, so that it appears in the node pane with a category, color, name and an icon, code to configure the node, and help text. Nodes can have an input, and zero or more outputs.

FIG. 2B is a drawing illustrating an example contact closure node 212 in accordance with embodiments of the disclosed technology. A contact closure is a term used to describe discrete alarms, digital inputs, or simply alarm inputs. Contact closures are alarm points that can be only “ON or OFF”, “opened or closed”, or “Yes or No.” In some embodiments, the contact closures described herein are designed for connecting switches, buttons, motion detectors, or other devices that make an electrical connection between two conductors. Digital outputs are designed for connecting LED indicators, small relays, buzzers, pilot lights, and most anything that can be powered from a small DC voltage. Likewise, embodiments of the contact closure node 212 can include different and/or additional components or can be connected in different ways.

The contact closure corresponding to the contact closure node 212 can be selected using the selector 230, depending on which devices have been provisioned. For instance, a device corresponding to the front door can be provisioned as a new contact closure, which is displayed in the selector 230 of FIG. 2B that shows “any contact closure” and “front door.” Thus, by connecting the contact closure node 212 to the alarm node 214 of FIG. 2A and selecting the “front door” using the selector 230, the flow program 210 is configured to trigger an alarm when the front door is open.

### Runtime

Authoring a flow-based program using the editor 200 can occur separately from the program's runtime according to the split architecture 100 of FIG. 1. For instance, the program 210 can be authored in the cloud 104 (illustrated and described in more detail with reference to FIG. 1) and be saved as a JavaScript Object Notation (JSON). JSON is an open standard file format and data interchange format that uses human-readable text to store and transmit data objects consisting of attribute—value pairs and arrays. The program 210 is run on the hub 108. The flow 210 is authored in the cloud 104 or authored in a mobile device (e.g., a user device) and transferred to the hub 108. The hub 108 then runs a virtual machine that executes the code blocks. A virtual machine (VM) is the virtualization or emulation of a computer system based on a computer architecture and provides the functionality of a physical computer. The split architecture increases privacy by separating the authoring process from the entity's private data. Furthermore, the split architecture allows automations to run without connecting devices to the internet. The devices are connected to the entity's hub 108, which executes flows locally.

The flow program 210 can be created in the editor 200 and exported as a JSON. Then when the program 210 is run, a separate flow interpreter reads the JSON. The flow interpreter looks at the schema of each node and can listen for incoming signals, for example, from a contact closure. When the contact closure fires an event, the event is transferred to another service with another topic line, so the service that received the event does not know where it comes from. Similarly, the contact closure does not know that some service on the other end listens for the event. Separate flows can be run in separate processes.

An entity can connect flows to other flows. This can be facilitated by a node that publishes an event in a main space, so other flows can listen for those published events. Two flows can be “stuck” to each other in this manner. Furthermore, not only can events generated by one flow be used by other flows, but they can be used by services. This enables an entity to string together any number of flows and services in any order and have them all working together.

In addition, because flows can be exported as JSON files, they can be easily shared with other entities. Notably, sharing flows allows entities to share automation processes without sharing device information. For example, as shown in FIG. 2B, a first entity can share a flow that includes a contact closure node 212 that is usable with “any contact closure,” without specifying a device that corresponds to the contact closure. A second entity who uses the shared flow can then select a device provisioned at the entity's local hub 108 to use for the contact closure, for example using the selector 230. In this manner, neither the first entity nor the second entity needs to share any device information with the other entity. The only information that is shared is the flow that describes the automation. Furthermore, each entity can clearly visualize how data moves within a flow using the flow editor 200, providing additional security against unauthorized leaking of data or other unauthorized uses.

In some implementations, flows are shared only between individual entities, such as between family members. In some implementations, flows are shared publicly, such as in a marketplace. Entities can publish their own flows or install flows built by other entities from the marketplace. Sharing flows between entities can be distinguished from flows or services that are created by third-party device manufacturers, who generally will create these flows or services for their own devices.

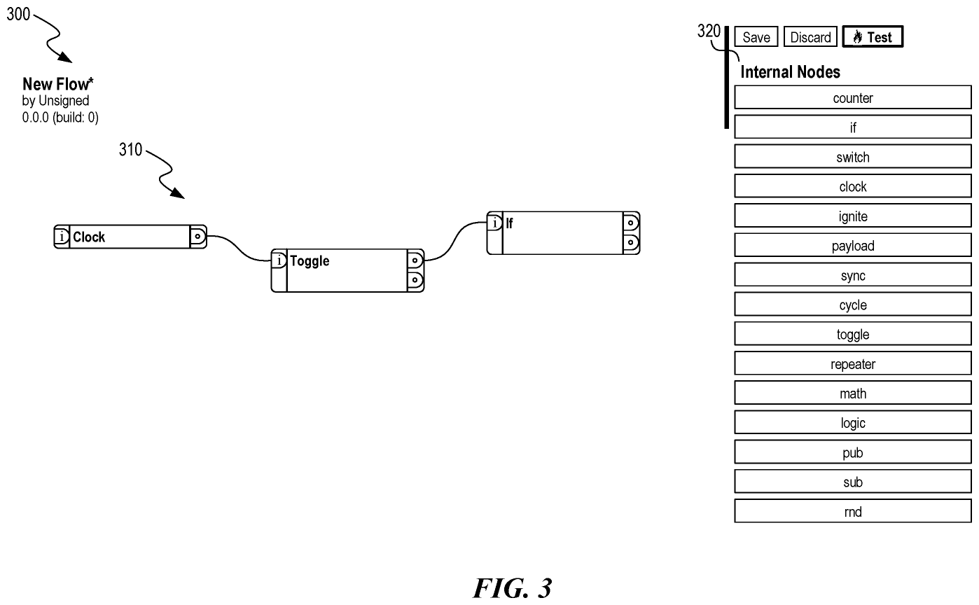

FIG. 3 is a drawing illustrating an example flow-based program editor 300 in accordance with embodiments of the disclosed technology. The editor 300 is similar to editor 200 (illustrated and described in more detail with reference to FIG. 2A). The flow 310 is an example flow showing how nodes can be connected to perform certain operations. Likewise, embodiments of the flow-based program editor 300 can include different and/or additional components or can be connected in different ways.

For example, the flow 310 can be used to make a light blink periodically as follows: the clock node 302 can be linked to a toggle node 304. The toggle node 304 alternates a true event and a false event, and connecting the clock node 302 will cause the toggle node 304 to emit the events periodically. Thus at one point in time t1, the toggle node 304 emits a true event and then at the next point in time t2 the toggle node 304 emits a false event, then true, then false, etc. By onboarding a lightbulb and linking a lightbulb node to the flow 310, the lightbulb can be caused to alternate on and off every second, thus blinking. The flow 310 can be configured to run for a limited time, such as five seconds.

The nodes 320 shown in FIG. 3 are examples of internal nodes. Internal nodes are generally not device-specific but provide useful functions for a variety of automations and devices. Internal nodes are built into the flow-based programming platform and available to an entity in the flow editor 300. Example internal nodes 320 include logical nodes, such as if, switch, toggle, etc. Implementation of the internal nodes can be configured into the flow interpreter that runs the flow programs. In contrast, external nodes implement functions outside of the flow interpreter. These external nodes can be provided by third parties. One example external node retrieves weather information, such as from the internet. In some implementations, external nodes from various third parties are unified in a single interface, rather than implementing different node bodies for each service.

The nodes 320 can communicate with other nodes and with services in various ways. For example, nodes can call other nodes through a local event emitter, such as one implemented by a flow interpreter. Nodes can use an external router or other I/O interface, such as an IOConnection or a standard WampConnection, to connect to service implementations. The IOConnection class represents a connection from a source signal to a target signal. In some implementations, internal nodes 320 communicate with an internal EventBus, and external nodes or service nodes communicate using a router connection. An EventBus is a pipeline that receives events. Rules associated with the EventBus evaluate events as they arrive. Each rule checks whether an event matches the rule's criteria.

Note that nodes can be distinguished from services. For example, there can be two ways to implement code that streams feed from a camera connected via USB. First, the code can be implemented as part of the internal nodes 320. The nodes can then be executed by a flow interpreter that runs on the hub 108. The result can be delivered to the flow editor 200 or 300 and displayed. Second, the code can be implemented as a service that exposes the expected WAMP endpoints to the flow service. The result of the code's execution can be passed to a flow interpreter that runs either in a browser or in the hub 108.

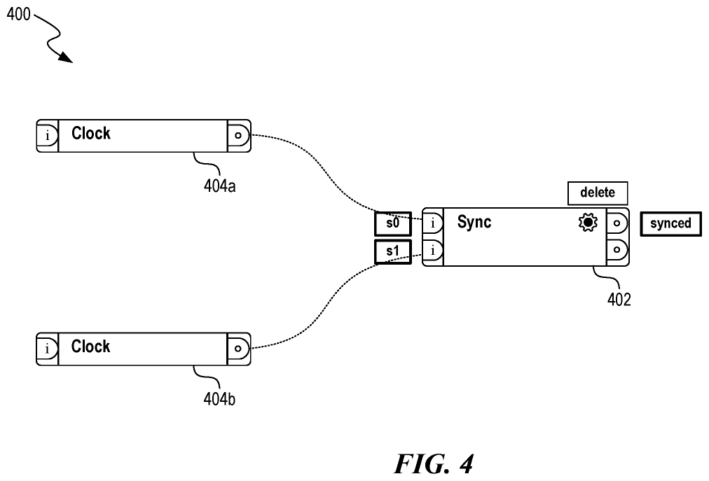

FIG. 4 is a drawing illustrating an example flow-based program 400 including a sync node 402 in accordance with embodiments of the disclosed technology. In some implementations, a specific flow is implemented in response to multiple asynchronous events to all occur before the flow executes. The sync node 402 waits for all of those events to occur before continuing with the flow. For example, the sync node 402 shown in FIG. 4 is configured to wait for data from the two clock nodes 404a-b before the flow executes further operations (not shown). Likewise, embodiments of the flow-based program 400 can include different and/or additional components or can be connected in different ways.

In a more concrete example, an entity may want to turn on a fan when a window is open and the temperature in a room is above 70 degrees Fahrenheit, because turning on air conditioning would waste energy if the window is open. To build this automation, the entity can connect a window node and a thermostat node to inputs of the sync node 402, with the fan node connected downstream from the sync node 402. Thus, the sync node 402 waits to receive inputs from both the window node and the thermostat node before the flow continues to the fan node, achieving the desired effect.

FIG. 5 illustrates a mapping interface 500 between nodes in accordance with embodiments of the disclosed technology. The flow-based programming platform implements a data mapping, such that the I/O of each node has its own schema. By selecting the link 510 between two nodes, e.g., the clock node 502 and the create node 504, an entity can configure the mapping between the two nodes 502 and 504. Likewise, embodiments of the mapping interface 500 can include different and/or additional components or can be connected in different ways.

For example, the clock node 502 emits two data types, a “count” and a “timestamp”, while the create node 504 receives “metadata” and “priority” data types. The flow-based programming platform enables entities to map disparate data types by selecting mapping rules in the mapping interface 500. For example, the “count” data, which is a number, is mapped from the clock node 502 to the “metadata” of the create node 504. This is performed on the interface 500 without the need for the entity to write additional code to make the data types compatible.

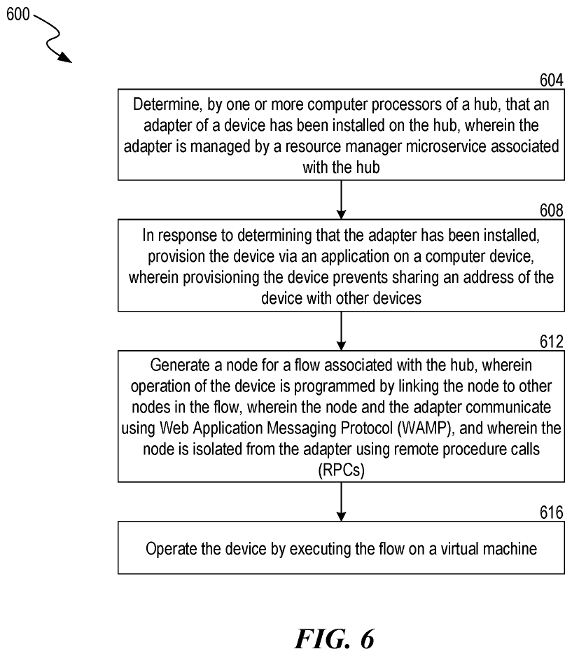

FIG. 6 illustrates a process 600 for operating a flow-based platform in accordance with embodiments of the disclosed technology. An example flow-based program editor 200 is illustrated and described in more detail with reference to FIG. 2A. In some embodiments, the process of FIG. 6 is performed by the hub 108 illustrated and described in more detail with reference to FIG. 1. In some embodiments, the process of FIG. 6 is performed by a computer system, e.g., the example computer system 800 illustrated and described in more detail with reference to FIG. 8. Particular entities, for example, the mapping interface 500, perform some or all of the acts of the process in some embodiments. The mapping interface 500 is illustrated and described in more detail with reference to FIG. 5. Likewise, embodiments can include different and/or additional acts, or perform the acts in different orders.

In act 604, one or more computer processors of a hub determine that an adapter of a device has been installed on the hub. An example hub 108 and example device 168 are illustrated and described in more detail with reference to FIG. 1. Adapters are described in more detail with reference to FIG. 2A. The adapter is managed by a resource manager microservice associated with the hub. The resource manager microservice is described in more detail with reference to FIG. 2A.

In act 608, in response to determining that the adapter has been installed, the one or more computer processors provision the device via an application on a computer device (e.g., a user device, a smartphone, etc.). Provisioning devices is described in more detail with reference to FIG. 2A. Provisioning the device prevents sharing an address of the device with other devices thus increasing security.

In act 612, the one or more computer processors generate a node for a flow associated with the hub. The node can be a contact closure node as illustrated in FIG. 2B. Nodes and flows are illustrated and described in more detail with reference to FIGS. 2A-5. Operation of the device is programmed by linking the node to other nodes in the flow. The node and the adapter communicate using a routing protocol. The routing protocol specifies the manner in which devices and entities communicate with each other to distribute information that enables them to select routes within the architecture 100 (illustrated and described in more detail with reference to FIG. 1). For example, data is forwarded from the node to the adapter until it reaches a destination. The routing protocol determines the specific choice of route. Each intermediate destination on the route may have prior knowledge only of networks attached to it directly. The routing protocol shares this information first among immediate neighbors, and then throughout the network. In some implementations, the routing protocol is a Web Application Messaging Protocol (WAMP).

In some embodiments, the node and the adapter communicate using WAMP. WAMP is described in more detail with reference to FIG. 1. In some embodiments, the one or more computer processors extract a feature vector from a voice command or a text command received from a user. The voice command or a text command is directed to the operation of the device, for example, “Turn off the light when I switch off the TV.” Example feature extraction methods are illustrated and described in more detail with reference to FIG. 7. A machine learning model can be used to generate the flow for operating the device based on the feature vector. Example machine learning methods and an example ML model 716 are illustrated and described in more detail with reference to FIG. 7.

The node can be isolated from the adapter using RPCs. RPCs are described in more detail with reference to FIG. 1. An RPC is implemented when a program causes a procedure (subroutine) to execute in a different address space (commonly on another computer on a shared network), which is written as if it were a normal (local) procedure call. A programmer writes essentially the same code whether the subroutine is local to the executing program, or remote. This is a form of client—server interaction (caller is client, executor is server), typically implemented via a request—response message-passing system. In the object-oriented programming paradigm, RPCs are represented by remote method invocation (RMI). The RPC model implies a level of location transparency, namely that calling procedures are largely the same whether they are local or remote, but usually, they are not identical, so local calls can be distinguished from remote calls. RPCs are a form of inter-process communication (IPC), in that different processes have different address spaces: if on the same host machine, they have distinct virtual address spaces, even though the physical address space is the same; while if they are on different hosts, the physical address space is different.

The node and other nodes in the flow can be rearranged to perform different functions, respond to triggers differently, and reorder activation of different devices. As described with reference to FIG. 2A, nodes can be arranged and interconnected as desired to manage the data flow. The nodes are movable within a user interface, such as by clicking and dragging on a desktop or laptop computer, or by providing a touchscreen input on a mobile device.

In act 616, the one or more computer processors operate the device by executing the flow on a virtual machine. Virtual machines are described in more detail with reference to FIG. 2B. In some implementations, the device is operated by executing the node using a flow interpreter that runs on the hub. Flow interpreters are described in more detail with reference to FIGS. 2B-3. The device can be operated while obviating the need to connect the device to the Internet.

### Additional Embodiments

In some implementations, applications are defined as networks of black box processes, which exchange data across predefined connections by message passing, where the connections are specified externally to the processes. These black box processes can be reconnected endlessly to form different applications without having to be changed internally. The embodiments described herein are therefore naturally component-oriented. For example, the flow-based embodiments described herein are a particular form of dataflow programming based on bounded buffers, information packets with defined lifetimes, named ports, and separate definition of connections.

The flow-based embodiments described herein view an application not as a single, sequential process, which starts at a point in time, and then completes one step at a time until it is finished, but as a network of asynchronous processes communicating by means of streams of structured data chunks, called information packets. The focus is on the application data and the transformations applied to it to produce the desired outputs. The network is defined externally to the processes, as a list of connections which is interpreted by a piece of software, usually called a scheduler. The processes communicate by means of fixed-capacity connections. A connection is attached to a process by means of a port, which has a name agreed upon between the process code and the network definition. More than one process can execute the same piece of code. At any point in time, a given information packet is typically “owned” by a single process, or be in transit between two processes. Ports may either be simple, or array-type. The combination of ports with asynchronous processes enable long-running primitive functions of data processing, such as Sort, Merge, Summarize, etc., to be supported in the form of software black boxes. Because the processes can continue executing as long they have data to work on and space for output, the applications generally run in less elapsed time than conventional programs, and make optimal use of all the processors on a machine, with no special programming required to achieve this.

In the flow-based embodiments described herein, the network definition is usually diagrammatic, and is converted into a connection list in a lower-level language or notation. More complex network definitions can have a hierarchical structure, being built up from subnets with “sticky” connections. In addition, the flow-based embodiments exhibit “data coupling” related to that of service-oriented architectures, and fit a number of the criteria for such an architecture. The implementations herein enable higher-level, functional specifications that simplify reasoning about system behavior. An example of this is the distributed data flow model for constructively specifying and analyzing the semantics of distributed multi-party protocols.

In the flow-based embodiments described herein, the ports enable the same component to be used at more than one place in the network. In combination with a parametrization ability, ports provide the flow-based scripts described herein with a component reuse ability, making the architecture 100 (illustrated and described in more detail with reference to FIG. 1) a component-based architecture. Moreover, the implementations described herein may be non-preemptive or preemptive.

FIG. 7 illustrates a machine learning system 700 accordance with embodiments of the disclosed technology. The ML system 700 is implemented using components of the example computer system 800 illustrated and described in more detail with reference to FIG. 8. For example, the ML system 700 can be implemented using instructions programmed in the memory 810 (a non-transitory storage medium) illustrated and described in more detail with reference to FIG. 8. Likewise, embodiments of the ML system 700 can include different and/or additional components or be connected in different ways. The ML system 700 is sometimes referred to as a ML module.

The ML system 700 includes a feature extraction module 708 implemented using components of the example computer system 800 illustrated and described in more detail with reference to FIG. 8. In some embodiments, the feature extraction module 708 extracts a feature vector 712 from input data 704. For example, the input data 704 can include patterns or videos of motion of people or objects as described in more detail with reference to FIG. 1. The input data can include a voice command or a text command. The feature vector 712 includes features 712a, 712b, . . . , 712n. The feature extraction module 708 reduces the redundancy in the input data 704, e.g., repetitive data values, to transform the input data 704 into the reduced set of features 712, e.g., features 712a, 712b, . . . , 712n. The feature vector 712 contains the relevant information from the input data 704, such that events or data value thresholds of interest can be identified by the ML model 716 by using the reduced feature representation. In some example embodiments, the following dimensionality reduction techniques are used by the feature extraction module 708: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

In alternate embodiments, the ML model 716 performs deep learning (also known as deep structured learning or hierarchical learning) directly on the input data 704 to learn data representations, as opposed to using task-specific algorithms. In deep learning, no explicit feature extraction is performed; the features 712 are implicitly extracted by the ML system 700. For example, the ML model 716 can use a cascade of multiple layers of nonlinear processing units for implicit feature extraction and transformation. Each successive layer uses the output from the previous layer as input. The ML model 716 can thus learn in supervised (e.g., classification) and/or unsupervised (e.g., pattern analysis) modes. The ML model 716 can learn multiple levels of representations that correspond to different levels of abstraction, wherein the different levels form a hierarchy of concepts. The different levels configure the ML model 716 to differentiate features of interest from background features.

In alternative example embodiments, the ML model 716, e.g., in the form of a convolutional neural network (CNN), generates the output 724, without the need for feature extraction, directly from the input data 704. The output 724 is provided to the computer device 728 or the hub 108 illustrated and described in more detail with reference to FIG. 1. The computer device 728 is a server, computer, tablet, smartphone, or smart speaker implemented using components of the example computer system 800 illustrated and described in more detail with reference to FIG. 8. In some embodiments, the steps performed by the ML system 700 are stored in memory on the computer device 728 for execution. In some embodiments, the output 724 is displayed on a screen of the hub 108 or smart devices 164, 168, 172 illustrated and described in more detail with reference to FIG. 1.

A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field can be approximated mathematically by a convolution operation. CNNs are based on biological processes and are variations of multilayer perceptrons designed to use minimal amounts of preprocessing.

The ML model 716 can be a CNN that includes both convolutional layers and max pooling layers. The architecture of the ML model 716 can be “fully convolutional,” which means that variable sized sensor data vectors can be fed into it. For all convolutional layers, the ML model 716 can specify a kernel size, a stride of the convolution, and an amount of zero padding applied to the input of that layer. For the pooling layers, the model 716 can specify the kernel size and stride of the pooling.

In some embodiments, the ML system 700 trains the ML model 716, based on the training data 720, to correlate the feature vector 712 to expected outputs in the training data 720. As part of the training of the ML model 716, the ML system 700 forms a training set of features and training labels by identifying a positive training set of features that have been determined to have a desired property in question, and, in some embodiments, forms a negative training set of features that lack the property in question.

The ML system 700 applies ML techniques to train the ML model 716, that when applied to the feature vector 712, the ML model 716 outputs indications of whether the feature vector 712 has an associated desired property or properties, such as a probability that the feature vector 712 has a particular Boolean property, or an estimated value of a scalar property. The ML system 700 can further apply dimensionality reduction (e.g., via linear discriminant analysis (LDA), principal component analysis (PCA), or the like) to reduce the amount of data in the feature vector 712 to a smaller, more representative set of data.

The ML system 700 can use supervised ML to train the ML model 716, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, or CNNs are used. In some example embodiments, a validation set 732 is formed of additional features, other than those in the training data 720, which have already been determined to have or to lack the property in question. The ML system 700 applies the trained ML model 716 to the features of the validation set 732 to quantify the accuracy of the ML model 716. Common metrics applied in accuracy measurement include: Precision and Recall, where Precision refers to a number of results the ML model 716 correctly predicted out of the total it predicted, and Recall is a number of results the ML model 716 correctly predicted out of the total number of features that had the desired property in question. In some embodiments, the ML system 700 iteratively re-trains the ML model 716 until the occurrence of a stopping condition, such as the accuracy measurement indication that the ML model 716 is sufficiently accurate, or a number of training rounds having taken place. The data enables the detected values to be validated using the validation set 732. The validation set 732 can be generated based on analysis to be performed.

In some embodiments, ML system 700 is a generative artificial intelligence or generative AI system capable of generating text, images, or other media in response to prompts. Generative AI systems use generative models such as large language models to produce data based on the training data set that was used to create them. A generative AI system is constructed by applying unsupervised or self-supervised machine learning to a data set. The capabilities of a generative AI system depend on the modality or type of the data set used. For example, generative AI systems trained on words or word tokens are capable of natural language processing, machine translation, and natural language generation and can be used as foundation models for other tasks. In addition to natural language text, large language models can be trained on programming language text, allowing them to generate source code for new computer programs. Generative AI systems trained on sets of images with text captions are used for text-to-image generation and neural style transfer.

### Computer System

FIG. 8 is a block diagram of a computer system 800 as may be used to implement features of some embodiments of the disclosed technology. The computer system 800 may be used to implement any of the entities, components or services depicted in the foregoing figures (and any other components described in this specification). The computer system 800 may include one or more central processing units (“processors”) 805, memory 810, input/output devices 825 (e.g., keyboard and pointing devices, display devices), storage devices 820 (e.g., disk drives), and network adapters 830 (e.g., network interfaces) that are connected to an interconnect 815. The interconnect 815 is illustrated as an abstraction that represents any one or more separate physical buses, point to point connections, or both connected by appropriate bridges, adapters, or controllers. The interconnect 815, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 810 and storage devices 820 are computer-readable storage media (e.g., non-transitory computer-readable storage media storing instructions) that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media can include computer-readable storage media (e.g., “non-transitory” media) and computer-readable transmission media.

The instructions stored in memory 810 can be implemented as software and/or firmware to program the processor(s) 805 to carry out actions described above. In some embodiments, such software or firmware may be initially provided to the computer system 800 by downloading it from a remote system through the computer system 800 (e.g., via network adapter 830).

It should be noted that the methods described above describe possible implementations, and that the operations and the steps may be rearranged or otherwise modified and that other implementations are possible. Furthermore, embodiments from two or more of the methods may be combined.

The functions described herein may be implemented in hardware, software executed by a processor, firmware, or any combination thereof. Other examples and implementations are within the scope of the disclosure and appended examples. Features implementing functions may also be physically located at various positions, including being distributed such that portions of functions are implemented at different physical locations.

As used herein, including in the examples, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal; however, it will be understood by a person of ordinary skill in the art that the signal may represent a bus of signals, where the bus may have a variety of bit widths.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms can be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms can on occasion be used interchangeably.

Consequently, alternative language and synonyms can be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications can be implemented by those skilled in the art.

From the foregoing, it will be appreciated that specific embodiments of the invention have been described herein for purposes of illustration, but that various modifications may be made without deviating from the scope of the invention. Rather, in the foregoing description, numerous specific details are discussed to provide a thorough and enabling description for embodiments of the present technology. One skilled in the relevant art, however, will recognize that the disclosure can be practiced without one or more of the specific details. In other instances, well-known structures or operations often associated with memory systems and devices are not shown, or are not described in detail, to avoid obscuring other aspects of the technology. In general, it should be understood that various other devices, systems, and methods in addition to those specific embodiments disclosed herein may be within the scope of the present technology.

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the examples, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following examples should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the examples. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of examples, certain implementations are presented below in certain example forms, but the applicant contemplates various aspects of an invention in other forms. For example, aspects of an example can be recited in a means-plus-function form or in other forms, such as being embodied in a computer-readable medium. An example intended to be interpreted as a mean-plus-function example will use the words “means for.” However, the use of the term “for” in any other context is not intended to invoke a similar interpretation. The applicant reserves the right to pursue such additional example forms in either this application or in a continuing application.

I/We claim:

1. A computer-implemented method for operating a device associated with a hub, the method comprising:
determining, by one or more computer processors of the hub, that an adapter of the device has been installed on the hub,
wherein the adapter is managed by a resource manager microservice associated with the hub;
in response to determining that the adapter has been installed, provisioning the device via an application on a computer device,
wherein provisioning the device prevents sharing an address of the device with other devices;
generating a node for a flow associated with the hub,
wherein operation of the device is programmed by linking the node to other nodes in the flow,
wherein the node and the adapter communicate using a routing protocol, and
wherein the node is isolated from the adapter using remote procedure calls (RPCs); and
operating the device by executing the flow on a virtual machine.

2. The computer-implemented method of claim 1, wherein the routing protocol is a Web Application Messaging Protocol (WAMP).

3. The computer-implemented method of claim 1, comprising rearranging the node and the other nodes in the flow.

4. The computer-implemented method of claim 1, wherein the node is a contact closure node.

5. The computer-implemented method of claim 1, wherein the node implements programmable logic.

6. The computer-implemented method of claim 1, wherein the device is operated while obviating the need to connect the device to the Internet.

7. The computer-implemented method of claim 1, wherein operating the device comprises executing the node using a flow interpreter that runs on the hub.

8. The computer-implemented method of claim 1, comprising:
extracting a feature vector from a voice command or a text command, wherein the voice command or a text command is directed to the operation of the device; and
generating, using a machine learning model, the flow for operating the device based on the feature vector.

9. A computer system for operating a device associated with a hub, the computer system comprising:
one or more computer processors; and
a non-transitory computer-readable storage medium storing instructions, which when executed by the one or more computer processors, cause the computer system to:
determine that an adapter of the device has been installed on the hub;
in response to determining that the adapter has been installed, provision the device via an application on a computer device;
extract a feature vector from a voice command or a text command, wherein the voice command or a text command is directed to the operation of the device;
generate, using a machine learning model, a flow for operating the device based on the feature vector, wherein the flow comprises a node associated with the device; and
operate the device by executing the flow on a virtual machine.

10. The computer system of claim 9, wherein the adapter is managed by a resource manager microservice associated with the hub.

11. The computer system of claim 9, wherein operation of the device is programmed by linking the node to other nodes in the flow.

12. The computer system of claim 9, wherein the node and the adapter communicate using Web Application Messaging Protocol (WAMP).

13. The computer system of claim 9, wherein the node is isolated from the adapter using remote procedure calls (RPCs).

14. The computer system of claim 9, wherein the instructions cause the computer system to rearrange the node and the other nodes in the flow.

15. The computer system of claim 9, wherein the node is a contact closure node.

16. The computer system of claim 9, wherein the node implements programmable logic.

17. The computer system of claim 9, wherein the device is operated while obviating the need to connect the device to the Internet.

18. The computer system of claim 9, wherein operating the device comprises executing the node using a flow interpreter that runs on the hub.

19. A non-transitory computer-readable storage medium storing instructions, which when executed by the one or more computer processors of a computer system, cause the computer system to:
determine that an adapter of a device has been installed on a hub;
in response to determining that the adapter has been installed, provision the device via an application on a computer device;
generate a node associated with the device for a flow associated with the hub; and
operate the device by executing the flow on a virtual machine.

20. The non-transitory computer-readable storage medium of claim 8, wherein the instructions cause the computer system to rearrange the node and the other nodes in the flow.
